(19) United States
(12) Patent Application Publication
(10) Pub. No.: US 2014/0227990 A1
(43) Pub. Date: Aug. 14, 2014

(54) COMMUNICATION SYSTEM AND METHOD OF OPERATION

(71) Applicant: DELPHI TECHNOLOGIES, INC., TROY, MI (US)

(72) Inventor: GLENN A. WALKER, GREENTOWN, IN (US)

(73) Assignee: DELPHI TECHNOLOGIES, INC., TROY, MI (US)

(21) Appl. No.: 14/193,100

(22) Filed: Feb. 28, 2014

Related U.S. Application Data
(63) Continuation-in-part of application No. 13/621,960, filed on Sep. 18, 2012, now Pat. No. 8,712,364.

(51) Int. Cl. H04W 52/02

(52) U.S. Cl. CPC H04W 52/0216; H04W 52/0219
USPC 455/343.4

(57) ABSTRACT

A communication system configured to communicate receiver-specific information from a transmitter to a plurality of receivers. Each of the receivers is assigned to one of a plurality of groups based on a group identification value stored in each receiver. A first receiver group is configured to operate during a first information-expected time interval. The first information-expected time interval is determined based on a reception time of a time-reference signal and a first group identification value. A second receiver group is configured to operate during a second information-expected time interval distinct from the first information-expected time interval. The second information-expected time interval is determined based on the reception time of the time-reference signal and a second group identification value.

### CROSS-REFERENCE TO RELATED APPLICATION

This application is a continuation-in-part application and claims the benefit of U.S. patent application Ser. No. 13/621960, entitled IN-VEHICLE COMMUNICATION SYSTEM AND METHOD OF OPERATION, and filed on 18 Sep 2012, the entire disclosure of which is hereby incorporated herein by reference.

### TECHNICAL FIELD OF INVENTION

This disclosure generally relates to a communication system with a plurality of receivers, and more particularly relates to periodically activating a first receiver group during a first information-expected time interval and a second receiver group during a distinct second information-expected time interval.

BACKGROUND OF INVENTION

Communication systems such as satellite digital audio radio services (SDARS) are known. Such communication systems may have thousands or millions of receivers. In some instances, receiver-specific information is transmitted that is relevant to only a portion or sub-group of the entire population of receivers. Receivers installed in vehicles receive electrical power from a battery, so it is preferable to minimize electrical power consumption. If a receiver in the vehicle is always on so that all receiver-specific information or messages are received, the receiver may draw too much power from the vehicle battery, especially if the vehicle is parked for extended periods of time.

### SUMMARY OF THE INVENTION

Described herein is a system and method for operating a plurality of receivers in groups. The groups of receivers periodically turns on when receiver-specific information relevant to a particular group is expected to be available for reception, and turns the receiver off when possible to conserve battery power.

In accordance with one embodiment, a communication system configured to communicate receiver-specific information from a transmitter to a plurality of receivers is provided. Each of the receivers is assigned to one of a plurality of groups based on a group identification value stored in each receiver. The system includes a first receiver group and a second receiver group. The first receiver group is configured to operate from an off-state to an on-state to receive receiver-specific information during a first information-expected time interval. The first information-expected time interval is determined based on a reception time of a time-reference signal and a first group identification value. The second receiver group is configured to operate from an off-state to an on-state to receive receiver-specific information during a second information-expected time interval. The information-expected time interval is distinct from the first information-expected time interval. The second information-expected time interval is determined based on the reception time of the time-reference signal and a second group identification value.

In another embodiment, a method of operating a communication system configured to communicate receiver-specific information from a transmitter to a plurality of receivers is provided. Each of the receivers is assigned to one of a plurality of groups based on a group identification value stored in each receiver. The transmitter is configured to transmit periodically a time-reference signal and the receiver-specific information. Information for a first receiver group is transmitted during a first information-expected time interval that is determined based on a reception time of a time-reference signal and a first group identification value. Information for a second receiver group is transmitted during a second information-expected time interval that is determined based on the reception time of the time-reference signal and a second group identification value. The second information-expected time interval is distinct from the first information-expected time interval. The method includes the step of determining a receiver identification value of a first receiver group and a second receiver group of the system. The method also includes the step of operating the first receiver group and the second receiver group to determine the reception time. The method also includes the step of operating the first receiver group during the first information-expected time interval to receive receiver-specific information if the receiver identification value corresponds to the first group identification value. The method also includes the step of operating the second receiver group during the second information-expected time interval to receive receiver-specific information if the receiver identification value corresponds to the second group identification value.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a communication system in accordance with one embodiment;

FIG. 2 is a timing diagram of signals present in the system of FIG. 1 in accordance with one embodiment; and

FIG. 3 is a flowchart of steps performed by the system of FIG. 1 in accordance with one embodiment.

### DETAILED DESCRIPTION

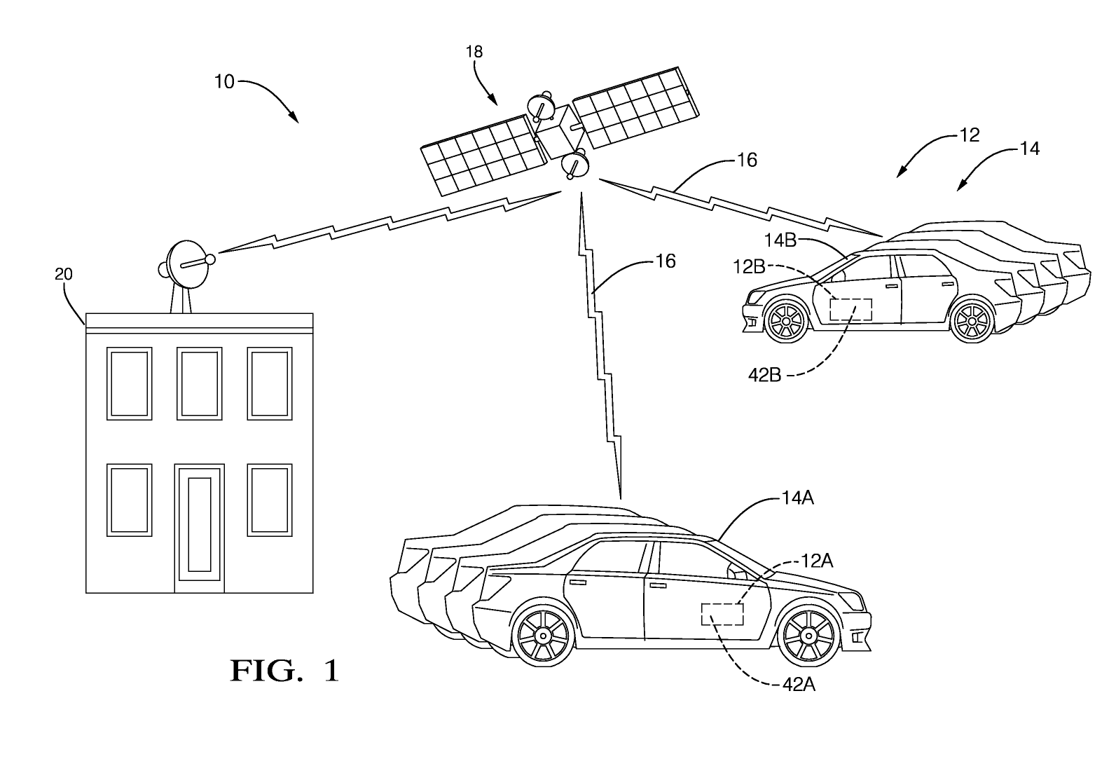

FIG. 1 illustrates a non-limiting example of a communication system, hereafter the system 10. The system 10 may include a plurality of receivers 12 installed in a plurality of vehicles 14. By way of example and not limitation, the receivers 12 may be receivers for a satellite digital audio radio services (SDARS) that broadcasts signals 16 from a transmitter 18. The signals 16 may include music, news, and text information, as will be recognized by those in the art. By way of further example, the transmitter 18 may be a satellite configured to receive communications from a ground station 20 that uplinks receiver-specific information to the transmitter 18 for generating the signals 16 that include the receiver-specific information for the receivers 12. In general, the receivers 12 are characterized as each having a receiver identification value that may uniquely identify the receiver relative to any other receiver receiving the signals 16, or may identify the receiver 12 as one of a particular collection of receivers that may react similarly to the receiver-specific information communicated by the signals 16. FIG. 1 illustrates an example of such grouping by showing a first receiver group 12A each installed in one of a first vehicle group 14A, and a second receiver group 12B each installed in one of a second vehicle group 14B.

The receiver identification value stored in a particular receiver may be related to the vehicle identification number (VIN) of the particular vehicle in which the receiver is installed, or may be related to a manufacturing serial number assigned to the receiver, or may be a combination thereof. The receiver may include a tuner, demodulator, or other circuitry known in the art for receiving and processing the signals 16, such as radio frequency (RF) signals. The receiver may include a processor (not shown) such as a microprocessor or other control circuitry as should be evident to those in the art. The receiver may include memory, including non-volatile memory, such as electrically erasable programmable read-only memory (EEPROM) for storing one or more routines, thresholds and captured data. The one or more routines may be executed by the processor to perform steps for determining signals received by the receiver as described herein.

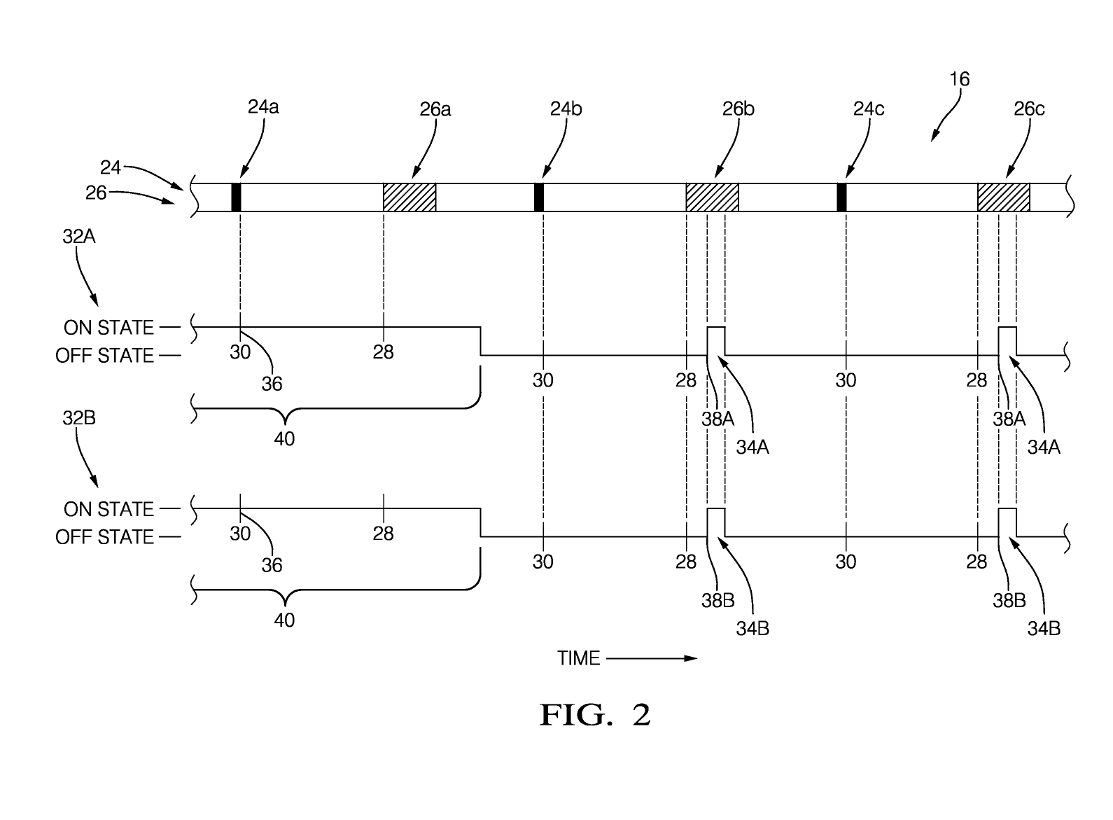

FIG. 2 illustrates a non-limiting example of information communicated in time slots of the signals 16 transmitted by the transmitter 18. The signals 16 may include a time-reference signal 24 (e.g. 24a, 24b, 24c) and receiver-specific information 26 (e.g. 26a, 26b, 26c) that are periodically transmitted. The time-reference signal 24 may be based on Coordinated Universal Time (UTC) signal received by the transmitter 18. The receiver-specific information 26 may include messages for other receivers (not shown) as well as a message specifically for the first receiver group 12A or the second receiver group 12B. For the purpose of explanation and not limitation, FIG. 2 illustrates an information transmission time 28 that generally marks the beginning of when the receiver-specific information 26 (e.g. 26a, 26b, 26c) is transmitted, and a reference transmission time 30 that generally marks the end of the time-reference signal 24. It is appreciated that the reference transmission time 30 could alternatively mark the beginning of the time-reference signal 24. As used herein, describing the time-reference signal 24 as being transmitted periodically means that the time interval between the time-reference signal 24a and the time-reference signal 24b is essentially equal to the time interval between the time-reference signal 24b and the time-reference signal 24c. As such, successive marks for the reference transmission time 30 are equally spaced over time. Similarly, the marks for the information transmission time 28 are equally spaced, and so the time interval between the reference transmission time 30 and the information transmission time 28 that immediately follows is essentially constant.

FIG. 2 further illustrates a non-limiting example of a first receiver activation schedule 32A for the first receiver group 12A, and a second receiver activation schedule 32B for the second receiver group 12B. In general, the first receiver group 12A is configured to operate from an off-state to an on-state and off again during a first information-expected time interval 34A effective to receive all or part of the receiver-specific information 26 for the first receiver group 12A. Similarly, the second receiver group 12B may be configured to operate from an off-state to an on-state and off again during a second information-expected time interval 34B effective to receive all or part of the receiver-specific information 26 for the second receiver group 12B. It should be recognized that some of the receiver-specific information 26 transmitted by the transmitter 18 may not be relevant to either the first receiver group 12A or the second receiver group 12B. As such, the first receiver activation schedule 32A and the second receiver activation schedule 32B are determined so that the first receiver group 12A or the second receiver group 12B is activated (i.e. powered on) only when information relevant to a particular receiver group is expected to be available for reception. As will be explained in more detail below, the first information-expected time interval 34A and the second information-expected time interval 34B may be determined based on a reception time 36 of the time-reference signal 24 (i.e. the reference transmission time 30) and the respective first receiver identification value 42A or second receiver identification value 42B stored in the respective receivers. The receiver identification value may be used to determine a first start time 38A or a second start time 38B based on when the first information-expected time interval 34A and/or the second information-expected time interval 34B will begin.

By way of further example, part of the receiver identification value, the last eight (8) bits for example, may be used to determine the first start time 38A or the second start time 38B relative to the reception time 36. Then, the first receiver group 12A or the second receiver group 12B can turn on at a time when relevant information is expected, and otherwise be turned off to save battery power. It should be recognized that the timing offset duration would be ‘known’ to the first receiver group 12A or the second receiver group 12B, and transmitter 18. By way of further example, if the last 8 bits are used, the receiver-specific information 26 (26a, 26b, or 26c) may be divided into two hundred fifty six (256) distinct time slots. The first receiver group 12A or the second receiver group 12B then can turn on, for example, two (2) seconds every five hundred twelve (512) seconds for receiver-specific information. The exact two seconds that the first receiver group 12A or the second receiver group 12B is on the on-state would be determined an offset duration relative to the reception time 36. This enables the receiver to be off 99.6% of the time while still being able to receive messages intended for it. The transmitter 18 only needs to transmit to the first receiver group 12A or the second receiver group 12B during the information-expected time interval 34. This improves the number of receivers that can be serviced in a broadcast system. At the end of the information-expected time intervals (34A, 34B), the first receiver group 12A, or the second receiver group 12B operates from the on-state to the off-state.

If the first receiver group 12A or the second receiver group 12B has not detected the reception time 36 of the time-reference signal 24, the first receiver group 12A or the second receiver group 12B may operate to the on-state for a synchronization time interval 40 to receive the time-reference signal 24. The maximum time of the synchronization time interval 40 would generally depend on how often the time-reference signal 24 was transmitted. The number of instances of the time-reference signal 24 a receiver would attempt to determine the reception time 36 before stopping (i.e. giving up) may be limited because, for example, the particular vehicle in which a particular receiver was installed was parked at a location where the signals 16 could not be received. Once the first receiver group 12A or the second receiver group 12B has determined the reception time 36, then an internal timer (not shown) within the various receivers 12 may be relied upon to activate the first receiver group 12A or the second receiver group 12B during a subsequent plurality of information-expected time intervals (34A, 34B) without having to determine the reference transmission time 30 immediately prior to determining every instance of the first start time 38A or the second start time 38B. As such, the first receiver group 12A or the second receiver group 12B may be configured to operate repeatedly only during the first information-expected time interval 34A or the second information-expected time interval 34B after an initial synchronization time interval 40, and before a subsequent synchronization time interval (not shown). In other words, once a time-reference signal 24 is received, a receiver can use an internal clock to receive multiple instances of receiver-specific information 26 before having to re-synchronize to the time-reference signal 24.

It is anticipated that the internal clock of a receiver and the clock used to determine when the time-reference signal 24 is transmitted may drift relative to each other, and so after activating a receiver only during an appropriate information-expected time interval, the receiver may need to resynchronize with the transmitter 18. Since the receiver has some prior ‘knowledge’ of when a time-reference signal may occur, the synchronization time interval 40 used initially by the receiver may be longer than a subsequent synchronization time interval (not shown). The determination of when a subsequent synchronization time interval should be performed may be decided based on several factors.

In one embodiment, a receiver may be configured to operate repeatedly only during the appropriate information-expected time interval a predetermined number of instances before the subsequent synchronization time interval. Such a strategy could be based on an expected worst case tolerance stack of the difference between the internal clock of a receiver, and the time based used by the transmitter 18.

In another embodiment, a receiver may be configured to operate repeatedly only during an information-expected time interval until a time-shift difference between the information-expected time interval and an information-arrival time interval (not shown, but understood to be the actual arrival time) is greater than a time-shift threshold. It is anticipated that the information-expected time interval will be greater than the actual time interval that a message for the specific receiver to allow time for a receiver to synchronize with the signals 16. If the message for a receiver arrives at an incremental amount of time different from expected, that difference can be used to determine that a subsequent synchronization should be performed.

In another embodiment, a receiver may be configured to operate repeatedly only during the information-expected time interval if a signal strength during the information-expected time interval is greater than a signal-strength threshold. If the signal strength is too low because, for example, the vehicle is parked in an underground structure, then the receiver may stop any further attempt to detect the signals 16 until, for example, the vehicle in which a receiver is installed is started.

Accordingly, described herein is a system 10 configured to communicate receiver-specific information 26 from a transmitter 18 to a plurality of receivers 12, wherein each of the receivers 12 is assigned to one of a plurality of groups based on a group identification value stored in each receiver. The system 10 includes a first receiver group 12A configured to operate from an off-state to an on-state to receive receiver-specific information 26 during a first information-expected time interval 34A, wherein the first information-expected time interval 34A is determined based on a reception time 36 of a time-reference signal 24 and a first group identification value 42A. The system 10 also includes a second receiver group 12B configured to operate from an off-state to an on-state to receive receiver-specific information 26 during a second information-expected time interval 34B distinct from the first information-expected time interval 34A. The second information-expected time interval 34B is determined based on the reception time 36 of the time-reference signal 24 and a second group identification value 42B. Such a configuration is advantageous to conserve battery power as a receiver only needs to be operating during certain time intervals instead of continuously.

In one embodiment, the receiver-specific information 26 during the first information-expected time interval 34A may be distinct from the receiver-specific information 26 during the second information-expected time interval 34B. That is information for the first receiver group 12A is different from information for the second receiver group 12B. In this way, information can be targeted for a particular model of receiver, or targeted to a particular make or model of vehicle.

In one embodiment, the first receiver group 12A may be further configured to operate from the on-state to the off-state before the second information-expected time interval 34B starts. That is, receivers in the first receiver group 12A are not operating at the same time as receivers in the second receiver group 12B. In other words, the second receiver group 12B may be configured to operate from an off-state to an on-state after the first receiver group 12A operates from the on-state to the off-state.

In general, the first information-expected time interval 34A is based on the reception time 36 and a portion of the first group identification value 42A. The difference in time between the reception time 36 and the first start time 38A may be stored in a look-up table in the receiver. The look-up table may be programmed at the time the receiver is manufactured, or may be communicated to the receiver by the transmitter as part of a receiver software update. The first group identification value 42A may be based on a particular vehicle identification number (VIN) of a particular vehicle in which a particular receiver is installed, or may be based on a manufacturing serial number of the receiver itself.

Continuing to refer to FIG. 2, the first receiver group 12A may be configured to operate during a synchronization time interval 40 to determine the reception time 36 of the time-reference signal 24, and operate during the first information-expected time interval 34A to receive receiver-specific information 26. As illustrated, the receiver may occasional be on for a long period of time so that the reception time 36 and the subsequent information transmission time 28 that marks the beginning of the receiver-specific information 26a can be learned. Then subsequent occurrences of the first information-expected time interval 34A can be timed without having to detect subsequent occurrences of the information transmission time 28. Optionally, the first receiver group 12A may be configured to operate only during a predetermined number of the first information-expected time interval 34A that occur after the synchronization time interval 40 and then wait for a subsequent synchronization time interval. This is one way to prevent a timing shift at the receiver relative to the transmitter 18 from causing the first information-expected time interval 34A from being missed by a receiver that is part of the first receiver group 12A.

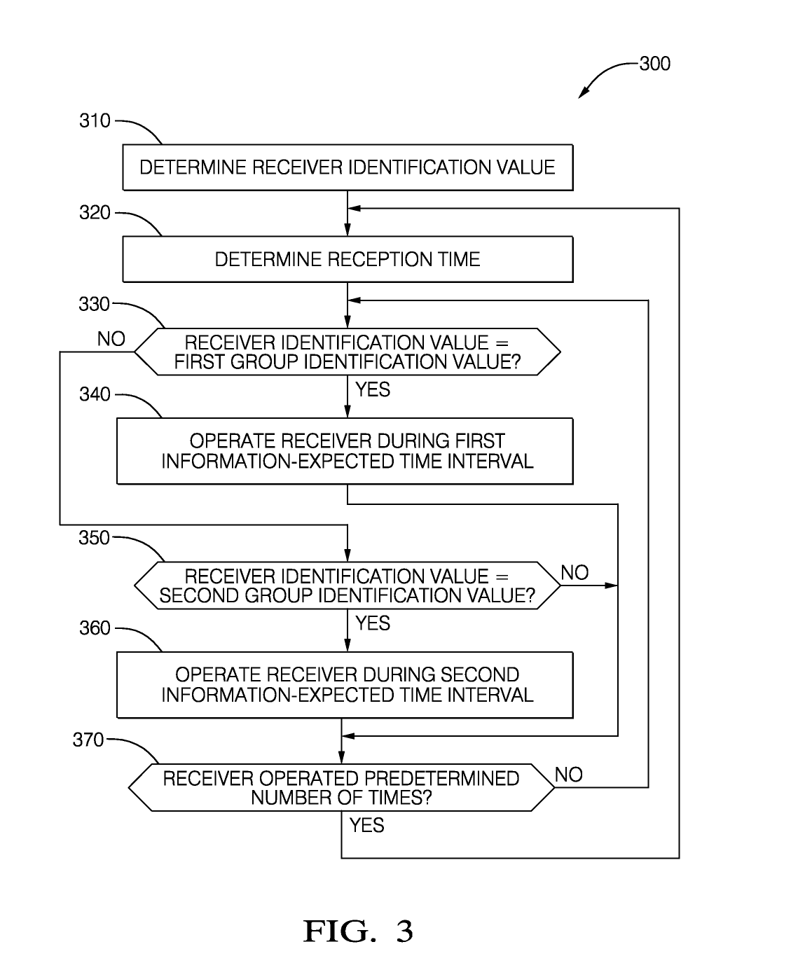

FIG. 3 illustrates a non-limiting example of a method 300 of operating a communication system (the system 10) configured to communicate receiver-specific information 26 from a transmitter 18 to a plurality of receivers 12. Each of the receivers is assigned to one of a plurality of groups based on a group identification value stored in each receiver. The transmitter 18 is configured to transmit periodically a time-reference signal 24 and the receiver-specific information 26. Information for a first receiver group 12A is transmitted during a first information-expected time interval 34A that is determined based on a reception time 36 of a time-reference signal 24 and a first group identification value 42A. Information for a second receiver group 12B is transmitted during a second information-expected time interval 34B that is determined based on the reception time 36 of the time-reference signal 24 and a second group identification value 42B. The second information-expected time interval 34B is distinct from the first information-expected time interval 34A.

Step 310, DETERMINE RECEIVER IDENTIFICATION VALUE, may include a receiver in the first receiver group 12A recalling from memory a receiver a first group identification value 42A. The first group identification value 42A may be based on, for example, the VIN of the vehicle in which the receiver is installed. As such, a way of determining a receiver identification value of a first receiver group 12A and a second receiver group 12B of the system 10 is provided.

Step 320, DETERMINE RECEPTION TIME, may include operating the receiver to detect the reception time 36 transmitted by the transmitter 18. The reception time 36 may be used to time subsequent activations of the receiver during the first information-expected time interval 34A when information relevant to the receiver is being broadcast. As such, a way of operating the first receiver group 12A and the second receiver group 12B to determine the reception time 36 is provided.

Step 330, RECEIVER IDENTIFICATION VALUE=FIRST GROUP IDENTIFICATION VALUE?, may include comparing the first group identification value 42A to a look-up table to determine a timer interval between the reception time 36 and a first start time 38A of a first information-expected time interval 34A. Alternatively, the timer interval between the reception time 36 and a first start time 38A of a first information-expected time interval 34A may be broadcast by the transmitter 18 during the synchronization time interval 40 and stored by the receiver. If the values do not correspond or match, the method 300 skips to step 350.

Step 340, OPERATE RECEIVER DURING FIRST INFORMATION-EXPECTED TIME INTERVAL, may include operating the first receiver group 12A to determine the reception time 36. Step 340 may also include operating a timer within the receiver to determine the time since the reception time 36 was determined, and then activating the receiver's reception devices during the first information-expected time interval 34A so the signal 16 can be received. As such, a way of operating the first receiver group 12A during the first information-expected time interval 34A to receive receiver-specific information 26 if the receiver identification value corresponds to the first group identification value 42A is provided.

Step 350, RECEIVER IDENTIFICATION VALUE=SECOND GROUP IDENTIFICATION VALUE?, may include executing operations similar to those for step 330 to determine if the receiver is in the second receiver group 12B and when the second information-expected time interval 34B is expected.

Step 360, OPERATE RECEIVER DURING SECOND INFORMATION-EXPECTED TIME INTERVAL, may include executing operations similar to those for step 340 but during the second information-expected time interval 34B. As such, a way of operating the second receiver group 12B during the second information-expected time interval 34B to receive receiver-specific information 26 if the receiver identification value corresponds to the second group identification value 42B is provided.

Step 370, RECEIVER OPERATED PREDETERMINED NUMBER OF TIMES?, may include counting the number of time steps 340 and/or 360 are performed as part of an effort to determine when a receiver should be operated to determine the synchronization time interval 40. By this, the first information-expected time interval 34A is repeated a predetermined number of times before repeating the step of operating the first receiver group 12A to determine the reception time 36, and/or the second receiver group 12B during the second information-expected time interval 34B is repeated the predetermined number of times before repeating the step of operating the second receiver group 12B to determine the reception time 36.

Accordingly, a communication system (the system 10) and a method 300 of operating a communication system is provided. By using the VIN or unique receiver ID number, a subset can be created based on a modulo version of that number. I.e. if 256 values are desired in a subset, only 8 bits of the digitized VIN/ID is needed. These bits are known at the receiver 12 and transmitter 18. Unique transmission times are sliced into the same amount as the subset (i.e. 256) and both the receiver and transmitter are pre-determined on what time they will transmit/receive. The offset time for each slice is based on a known time that is transmitted by the broadcast system and is known by the receiver 12, or a close estimate can be calculated. This provides a way to ensure the transmitter only transmits messages when it knows the intended receiver is on. It also ensures that the receiver is on only when messages for the receiver are expected to be received.

While this invention has been described in terms of the preferred embodiments thereof, it is not intended to be so limited, but rather only to the extent set forth in the claims that follow.

We claim:

1. A communication system (10) configured to communicate receiver-specific information (26) from a transmitter (18) to a plurality of receivers (12), wherein each of the receivers (12) is assigned to one of a plurality of groups based on a group identification value stored in each receiver, wherein the system (10) comprises:
a first receiver group (12A) configured to operate from an off-state to an on-state to receive receiver-specific information (26) during a first information-expected time interval (34A), wherein the first information-expected time interval (34A) is determined based on a reception time (36) of a time-reference signal (24) and a first group identification value (42A); and
a second receiver group (12B) configured to operate from an off-state to an on-state to receive receiver-specific information (26) during a second information-expected time interval (34B) distinct from the first information-expected time interval (34A), wherein the second information-expected time interval (34B) is determined based on the reception time (36) of the time-reference signal (24) and a second group identification value (42B).

2. The system (10) in accordance with claim 1, wherein the receiver-specific information (26) during the first information-expected time interval (34A) is distinct from the receiver-specific information (26) during the second information-expected time interval (34B).

3. The system (10) in accordance with claim 1, wherein the first receiver group (12A) is further configured to operate from the on-state to the off-state before the second information-expected time interval (34B) starts.

4. The system (10) in accordance with claim 1, wherein the second receiver group (12B) is configured to operate from an off-state to an on-state after the first receiver group (12A) operates from the on-state to the off-state.

5. The system (10) in accordance with claim 1, wherein the first information-expected time interval (34A) is based on the reception time (36) and a portion of the first group identification value (42A).

6. The system (10) in accordance with claim 1, wherein the first group identification value (42A) is based on a particular vehicle identification number (VIN) of a particular vehicle in which a particular receiver is installed.

7. The system (10) in accordance with claim 1, wherein the first receiver group (12A) is configured to operate during a synchronization time interval (40) to determine the reception time (36) of the time-reference signal (24), and operate during the first information-expected time interval (34A) to receive receiver-specific information (26).

8. The system (10) in accordance with claim 7, wherein the first receiver group (12A) is configured to operate only during a predetermined number of the first information-expected time interval (34A) that occur after the synchronization time interval (40) and then wait for a subsequent synchronization time interval.

9. A method (300) of operating a communication system (10) configured to communicate receiver-specific information (26) from a transmitter (18) to a plurality of receivers, wherein each of the receivers is assigned to one of a plurality of groups based on a group identification value stored in each receiver, wherein the transmitter (18) is configured to transmit periodically a time-reference signal (24) and the receiver-specific information (26), wherein information for a first receiver group (12A) is transmitted during a first information-expected time interval (34A) that is determined based on a reception time (36) of a time-reference signal (24) and a first group identification value (42A), and information for a second receiver group (12B) is transmitted during a second information-expected time interval (34B) that is determined based on the reception time (36) of the time-reference signal (24) and a second group identification value (42B), wherein the second information-expected time interval (34B) is distinct from the first information-expected time interval (34A), said method (300) comprising:
determining a receiver identification value of a first receiver group (12A) and a second receiver group (12B) of the system (10);
operating the first receiver group (12A) and the second receiver group (12B) to determine the reception time (36);
operating the first receiver group (12A) during the first information-expected time interval (34A) to receive receiver-specific information (26) if the receiver identification value corresponds to the first group identification value (42A); and
operating the second receiver group (12B) during the second information-expected time interval (34B) to receive receiver-specific information (26) if the receiver identification value corresponds to the second group identification value (42B).

10. The method (300) in accordance with claim 9, wherein the step of operating the first receiver group (12A) during the first information-expected time interval (34A) is repeated a predetermined number of times before repeating the step of operating the first receiver group (12A) to determine the reception time (36).

11. The method (300) in accordance with claim 10, wherein the step of operating the second receiver group (12B) during the second information-expected time interval (34B) is repeated the predetermined number of times before repeating the step of operating the second receiver group (12B) to determine the reception time (36).
